(19) United States
(12) Patent Application Publication
(10) Pub. No.: US 2018/0018671 A1
(43) Pub. Date: Jan. 18, 2018

(54) SYSTEM AND METHODS FOR GENERATING, RECORDING, MANAGING AND REDEEMING GIFT CERTIFICATES THAT SECURELY RETAIN THEIR UNUSED BALANCE OVER MULTIPLE PARTIAL USES

(71) Applicant: Tickerware LLC, Jupiter, FL (US)

(72) Inventor: Anthony Celia, Jupiter, FL (US)

(73) Assignee: Tickerware LLC, Jupiter, FL (US)

(21) Appl. No.: 15/625,895

(22) Filed: Jun. 16, 2017

Related U.S. Application Data
(60) Provisional application No. 62/362,579, filed on Jul. 14, 2016.

(51) Int. Cl. G06Q 20/40; G06Q 20/34

(52) U.S. Cl. CPC G06Q 20/4016; G06Q 20/348; G06Q 20/401

(57) ABSTRACT

The present invention comprises a system and associated methods for protecting the unused balance of partially redeemed gift certificates from unauthorized, fraudulent use. The present invention employs a two-part gift certificate identification comprising a static Unique ID for gift certificate tracking, managing, reporting and reissuing and a separate, random Authentication Code that changes each time the gift certificate is reissued. The present invention fully enables a gift recipient's partial use of the gift certificate while retaining the unused balance for one or more future purchases. The present invention also enables the use of partially-redeemable gift certificates in “open loop” pools of unaffiliated merchants where typical gift certificates are generally limited to “closed loop,” single-merchant and single-use applications without retention of the unused balance. The system and methods described herein can be owned and operated by merchants operating their own “closed loop” gift certificate programs and by third parties managing “open loop” gift certificate programs for multiple unaffiliated merchants. In an embodiment, the scannable code includes a hash value and the computer processor is programmed to use a secure hashing algorithm to generate the hash value to produce the first gift certificate, such that a would-be counterfeiter who knows all gift certificate attributes would not know how to produce a valid hash.

This application is a non-provisional of and claims priority to U.S. Provisional Patent Application Ser. No. 62/362,579, filed Jul. 14, 2016, which is incorporated herein by reference in its entirety.

This application includes material which is subject to copyright protection. The copyright owner has no objection to the facsimile reproduction by anyone of the patent disclosure, as it appears in the Patent and Trademark Office files or records, but otherwise reserves all copyright rights whatsoever.

### FIELD

The present invention relates in general to the field of computer-processor based systems for generating, recording, managing and redeeming gift certificates, and in particular to systems and methods for doing so while securely retaining an unused balance after a partial use. In an embodiment, the problems to be solved are theft of unused balances and the need for additional gift certificates to be issued each time a gift certificate is partially used.

### BACKGROUND

Gift certificates offer a convenient way for gift givers to avoid cash gifts by allowing them to give currency-equivalent monetary value in a purchasing instrument that can be applied toward purchases without limiting the gift recipient's gift choices. The gift giver can choose a merchant who sells products or services that would appeal to the gift recipient, purchase a gift certificate of a chosen total value from the merchant and give the gift certificate to the gift recipient without requiring the gift giver to know the exact item or service that the gift recipient would want to purchase from the merchant. The gift recipient is then free to choose from among the selected merchant's products and services and to apply the gift certificate toward the purchase of those products or services.

Gift givers generally choose gift certificates over gift cards (cards in a debit or credit card format) for a number of reasons including, but not limited to the ability to purchase and give gift certificates in both digital form (e.g. e-mail attachment) and physical form (e.g. printed on paper), the ability to purchase the gift certificate on short notice for immediate fulfillment and the ability to easily customize the gift certificate design or to incorporate the gift certificate into another larger certificate (e.g. via digital copy and paste on a computer or cut and paste on paper).

Merchants choose to offer gift certificates over gift cards for a number of reasons, including, but not limited to the lower cost of a gift certificate (gift certificates typically don't require expensive media like magnetic cards), the ability to offer gift certificates without having to maintain an inventory of expensive blank cards and the ability to offer gift certificates without requiring special fulfillment and processing devices for implementing the gift certificate program.

Prior to this invention, gift givers purchased gift certificates knowing that gift certificates are usually limited to a single use (unable to retain an unused balance) and/or that the gift certificates can only be applied toward purchases at a single merchant (the merchant who issued the gift certificate). These limitations are generally due to the fact that, unlike a gift card which can be secured by digital protection mechanisms and may be backed by a financial institution like Visa, Master Card or American Express, a gift certificate may be easy to copy and forge for unauthorized, fraudulent use. Also, prior to this invention, once a merchant knew the gift certificate ID, there was nothing preventing merchant fraud where the merchant could deplete the gift certificate's unused balance after a gift recipient partially redeemed the gift certificate and the merchant now knew the gift certificate ID and remaining balance. While merchants would be less likely to commit such fraud if the gift certificate's unused balance could only be redeemed at their own store (i.e. a “closed loop” gift certificate), merchants might be tempted to deplete a gift certificate's remaining balance if the gift certificate were an “open loop” gift certificate where the remaining balance could be redeemed at another unaffiliated merchant. It could even be possible that a disgruntled merchant employee would deplete a gift certificate's unused balance for a variety of illicit reasons or that an employee may accidentally deplete the remaining unused balance of the gift certificate (e.g. by accidentally redeeming the gift certificate multiple times).

Prior to this invention, merchants would be reluctant to issue gift certificates that retained an unused balance, because, the merchant would have needed to implement some type of tracking system that associated the remaining balance with the gift certificate ID or the merchant would have needed to rely on a more rudimentary manual balance tracking system (e.g. writing the unused balance on the gift certificate and signing it). Methods employed by the merchant to enable retention of unused balances generally required a degree of trust of the consumer who possessed the gift certificate and a degree of manual effort by the merchant to track and manage the gift certificate. And even then, no rudimentary system could effectively secure and protect the unused balance from fraud in an “open loop” system where gift certificates can be redeemed at multiple, unaffiliated merchants.

### SUMMARY

Therefore, a need exists to provide a gift certificate that securely retains its unused balance (a) for the consumer who wants the freedom to partially redeem a gift certificate without forfeiting any of the gift certificate's total purchasing value, (b) for the gift giver who wants to maximize the gift recipient's perceived value of their gift, (c) for the merchant who wants to allow repeated, partial use of gift certificates and/or to participate in an “open loop” system with other unaffiliated merchants without worrying about intentional or even accidental depletion of the gift certificate's unused balance by an employee, and (d) for the gift certificate program implementer who wants to minimize the overhead associated with supporting and maintaining a system that facilitates partial redemption of gift certificates that securely retain their unused balances.

The present invention relates to a novel system and associated methods for protecting the unused balance of a gift certificate from theft. With this invention, gift certificates allow the gift recipient to partially redeem a gift certificate, knowing that the unused balance cannot be fraudulently used by an unauthorized merchant or by an unauthorized consumer. This invention has the added benefit of fully enabling “open loop” use of gift certificates that retain their unused balances, where gift certificates can be partially redeemed at one merchant and the remaining balance can later be redeemed at another participating merchant—all while protecting the unused balance of the gift certificate from unauthorized use by merchants and other consumers.

Gift certificates that securely retain their unused balance offer gift givers the opportunity to give a gift that has a higher perceived value, because the gift recipient does not feel limited to applying the gift certificate to a single purchase. And since a gift certificate that securely retains its unused balance is well suited to an “open loop” merchant pool of unaffiliated merchants, gift recipients can not only choose to partially redeem a gift certificate, they can partially redeem the same gift certificate at multiple unaffiliated merchants.

In an embodiment, the present invention comprises a gift certificate ordering, fulfillment and redemption system that associates two multi-symbol identifiers with each gift certificate. When a new gift certificate is purchased by a gift giver, the gift certificate is recorded in a database with its standard design attributes (e.g. color, style, message, gift giver name, gift recipient name, etc.), its value (its currency-equivalent monetary worth), a fixed, unique ID that is the primary database key for the gift certificate and a randomly generated Authentication Code known only by the gift recipient. Whenever the gift certificate is reissued (as, for example, would be the case when the gift certificate is partially redeemed and has a remaining, unused balance), the system and associated methods described herein reissue the gift certificate with a new, randomly generated Authentication Code that is different from any Authentication Code(s) previously associated with the Unique ID. The Unique ID provides a fixed primary key for the gift certificate record in the database, so that the record can be easily selected and updated while the new, randomly-generated Authentication Code protects the unused balance of the gift certificate from use by unauthorized persons who may know one or more of the previous gift certificate Authentication Codes. This novel system enables frictionless gift certificate redemption by the gift recipient in a manner that is just as easy for the gift recipient and the redeeming merchant as it would be if the gift certificate did not retain its unused balance and could be used only one time.

For the system implementer who may have attempted to implement a partially redeemable gift certificate program prior to this invention, reissued gift certificates would have required new IDs and thus new primary keys in the database. In an embodiment, since each gift certificate in the system retains its static identity via an unchanging Unique ID, the system and associated methods described herein fully support multiple, secure partial redemptions of gift certificates without unnecessary use of new Unique IDs that may otherwise result in rapid depletion of the pool of available Unique IDs and would otherwise create significant administrative overhead due to the required management of multiple IDs (primary keys) associated with what is essentially the same gift certificate. In an embodiment, each gift certificate in the system described herein is always selected and updated via its single Unique ID which remains its primary key for the recorded life of the gift certificate.

### BRIEF DESCRIPTION OF THE DRAWINGS

The foregoing and other objects, features, and advantages of the invention will be apparent from the following more particular description of preferred embodiments as illustrated in the accompanying drawings, in which reference characters refer to the same parts throughout the various views. The drawings are not necessarily to scale, emphasis instead being placed upon illustrating principles of the invention.

FIG. 1 shows a high-level system diagram that illustrates the interrelated objects comprising the system.

FIG. 2 illustrates the two-part gift certificate identification comprising the static Unique ID and the random Authentication Code.

FIG. 3 shows the first of three parts of the logical diagram that illustrates the process flow through the system.

FIG. 4 shows the second of three parts of the logical diagram that illustrates the process flow through the system.

FIG. 5 shows the third of three parts of the logical diagram that illustrates the process flow through the system.

FIG. 6A shows an example of a gift certificate with a scannable code that represents only the Gift Certificate ID.

FIG. 6B shows an example of production of the scannable code in FIG. 6A.

FIG. 7A shows an example of a gift certificate with a scannable code that represents the Gift Certificate ID and a hash of one gift certificate attribute (such as color).

FIG. 7B shows an example of production of the scannable code in FIG. 7A.

FIG. 8A shows an example of a gift certificate with a scannable code that represents the Gift Certificate ID and a hash of multiple combined attributes of the gift certificate (such as the color and personalized message).

FIG. 8B shows an example of production of the scannable code in FIG. 8A.

FIG. 9A shows an example of a gift certificate with scannable code that represents the Gift Certificate ID and a hash of multiple combined attributes of the gift certificate (such as the color and personalized message and additional attributes).

FIG. 9B shows an example of production of the scannable code in FIG. 9A.

FIG. 10 shows a block diagram of a data processing system that can be used in various embodiments of the disclosed systems and methods.

FIG. 11 shows a block diagram of a user device.

### DETAILED DESCRIPTION

Reference will now be made in detail to the preferred embodiments of the present invention, examples of which are illustrated in the accompanying drawings. The following description and drawings are illustrative and are not to be construed as limiting. Numerous specific details are described to provide a thorough understanding. However, in certain instances, well-known or conventional details are not described in order to avoid obscuring the description. References to one or an embodiment in the present disclosure are not necessarily references to the same embodiment; and, such references mean at least one.

Reference in this specification to “an embodiment” or “the embodiment” means that a particular feature, structure, or characteristic described in connection with the embodiment is included in at least an embodiment of the disclosure. The appearances of the phrase “in an embodiment” in various places in the specification are not necessarily all referring to the same embodiment, nor are separate or alternative embodiments mutually exclusive of other embodiments. Moreover, various features are described which may be exhibited by some embodiments and not by others. Similarly, various requirements are described which may be requirements for some embodiments but not other embodiments.

The present invention is described below with reference to block diagrams and operational illustrations of methods and devices for gift certificate ordering, fulfillment and redemption. It is understood that each block of the block diagrams or operational illustrations, and combinations of blocks in the block diagrams or operational illustrations, may be implemented by means of analog or digital hardware and computer program instructions. These computer program instructions may be stored on computer-readable media and provided to a processor of a general-purpose computer, special purpose computer, ASIC, or other programmable data processing apparatus, such that the instructions, which execute via the processor of the computer or other programmable data processing apparatus, implements the functions/acts specified in the block diagrams or operational block or blocks. In some alternate implementations, the functions/acts noted in the blocks may occur out of the order noted in the operational illustrations. For example, two blocks shown in succession may in fact be executed substantially concurrently or the blocks may sometimes be executed in the reverse order, depending upon the functionality/acts involved.

The terminology used herein is for the purpose of describing particular embodiments only and is not intended to be limiting of the invention. As used herein, the term “and/or” includes any and all combinations of one or more of the associated listed items. As used herein, the singular forms “a,” “an,” and “the” are intended to include the plural forms as well as the singular forms, unless the context clearly indicates otherwise. It will be further understood that the terms “comprises” and/or “comprising” when used in this specification, specify the presence of stated features, steps, operations, elements and/or components, but do not preclude the presence or addition of one or more other features, steps, operations, elements, components, and/or groups thereof.

Unless otherwise defined, all terms (including technical and scientific terms) used herein have the same meaning as commonly understood by one having ordinary skill in the art to which this invention belongs. It will be further understood that terms, such as those defined in commonly used dictionaries, should be interpreted as having a meaning that is consistent with their meaning in the context of the relevant art and the present disclosure and will not be interpreted in an idealized or overly formal sense unless expressly so defined herein.

In describing the invention, it will be understood that a number of techniques and steps are disclosed. Each of these has individual benefit and each can also be used in conjunction with one or more, or in some cases all, of the other disclosed techniques. Accordingly, for the sake of clarity, this description will refrain from repeating every possible combination of the individual steps in an unnecessary fashion. Nevertheless, the specification and claims should be read with the understanding that such combinations are entirely within the scope of the invention and the claims.

The present disclosure is to be considered as an exemplification of the invention, and is not intended to limit the invention to the specific embodiments illustrated by the figures or description below.

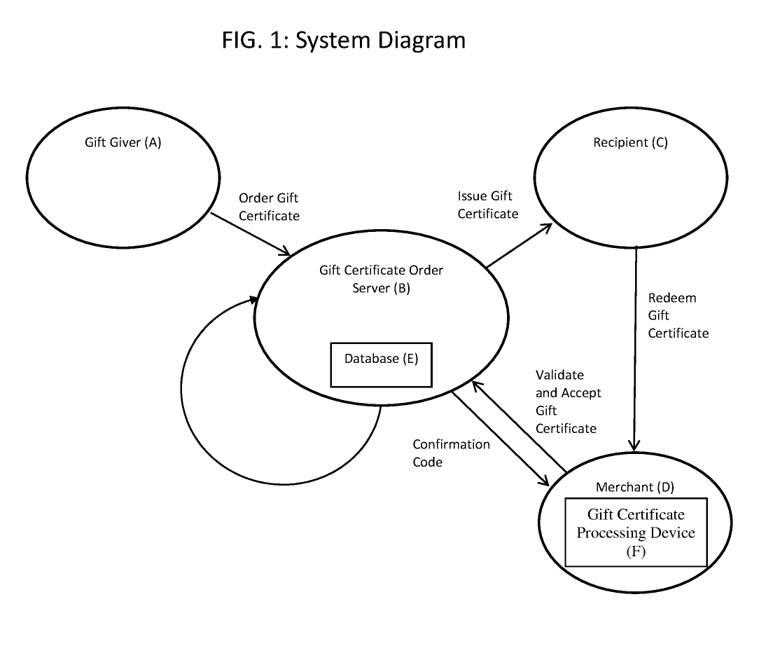

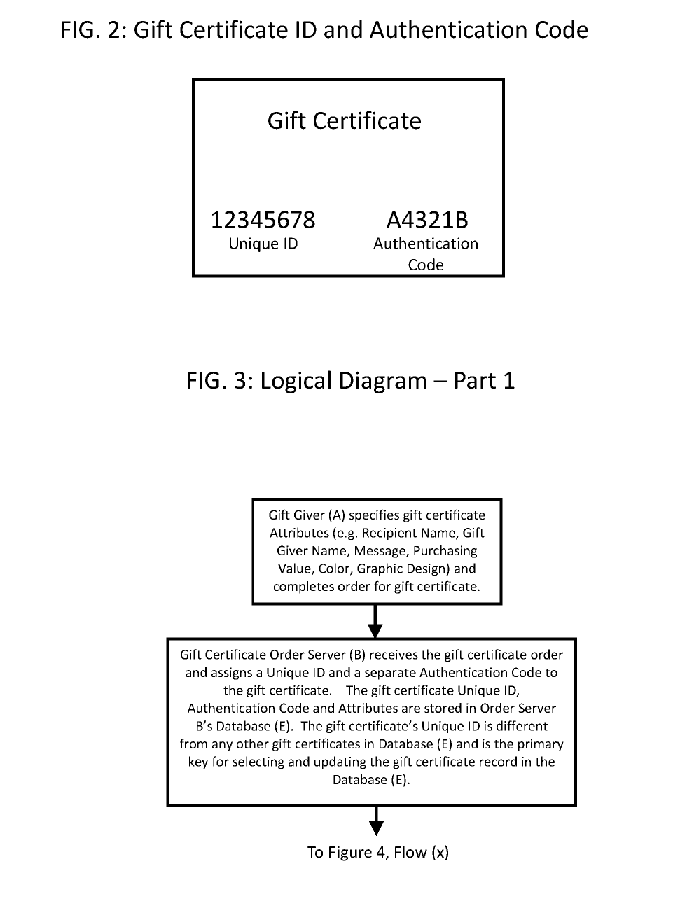

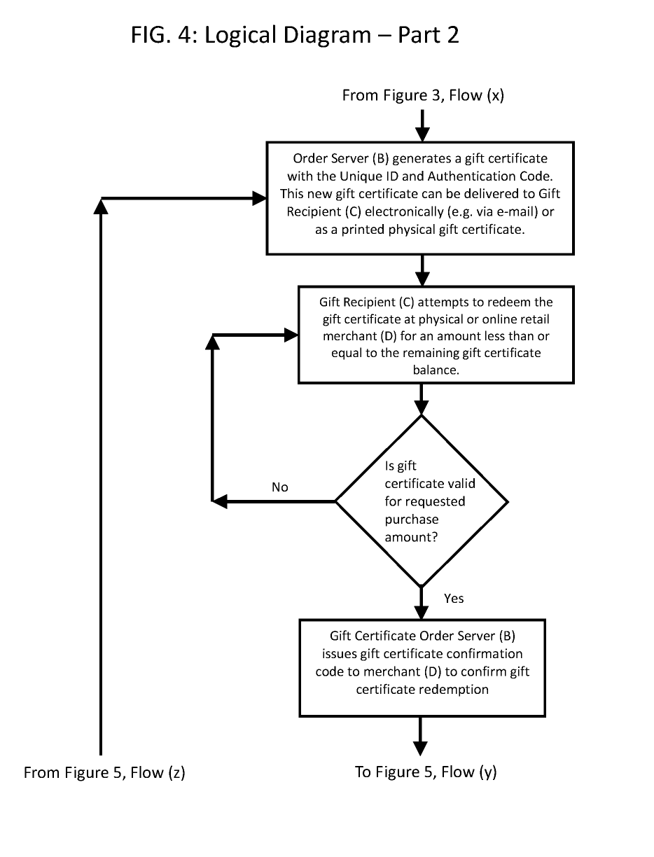

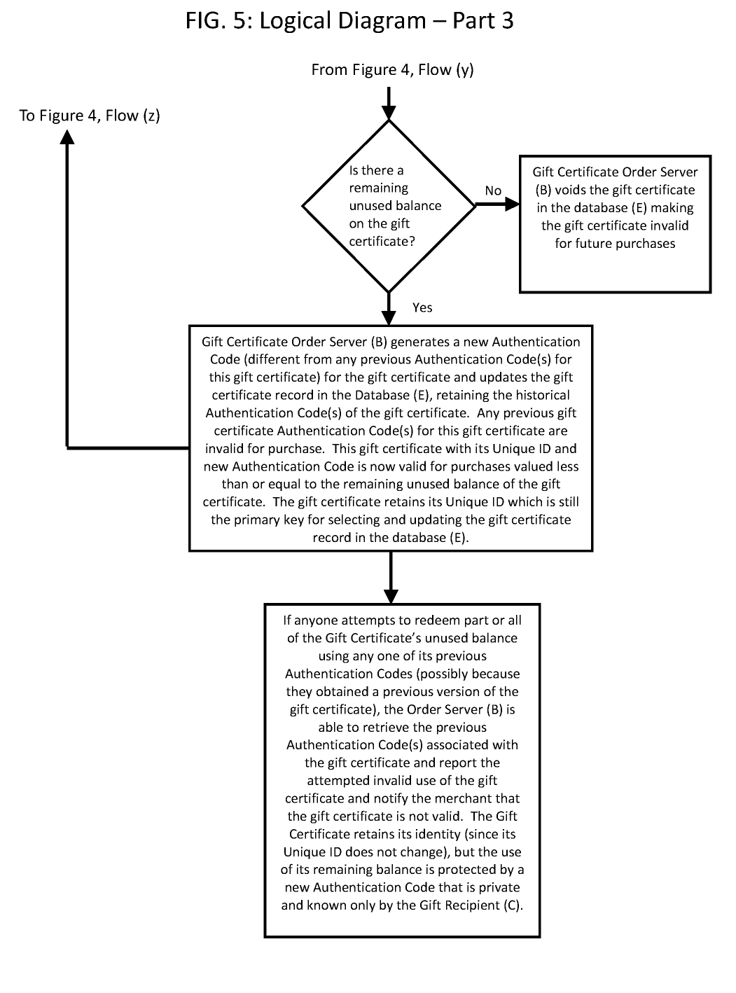

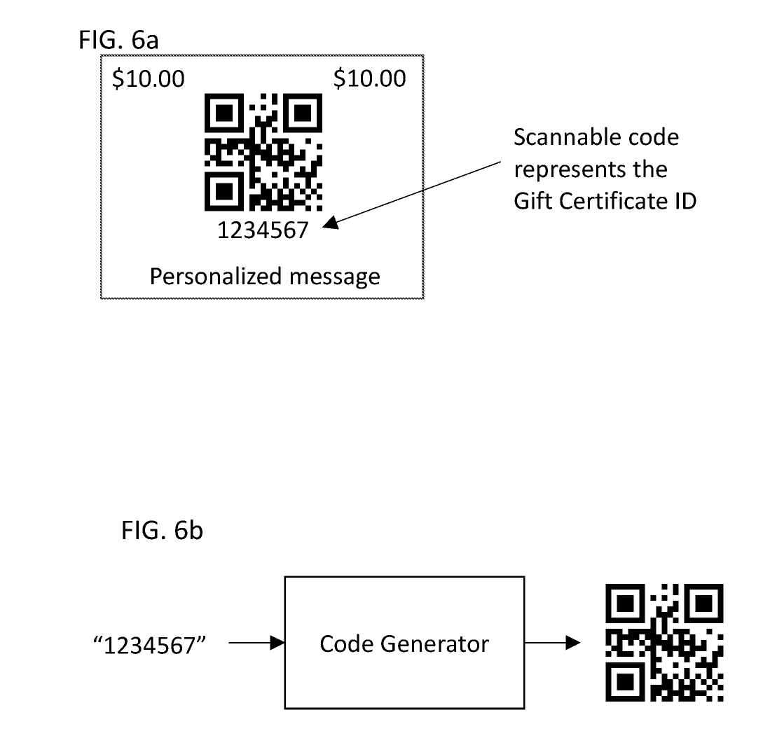

The present invention will now be described by referencing the appended figures representing preferred embodiments. FIG. 1 depicts the interrelated objects of the preferred system embodiment. FIG. 2 depicts the two-part identification of the gift certificate comprising the static Unique ID and the changing, random Authentication Code. FIGS. 3, 4 and 5 depict the logical process flow through the preferred system embodiment. FIGS. 6a through 9b illustrate a method for further protection of the unused gift certificate balance by preventing counterfeiting of a scannable gift certificate code.

The system and associated methods described herein apply equally to “closed loop” gift certificate systems (restricted to a single merchant) and to “open loop” systems that facilitate gift certificate use at multiple, unaffiliated merchants.

The system and associated methods described herein apply equally to scenarios where the Merchant (D) in FIG. 1 owns and operates their own Gift Certificate Order Server (B) in FIG. 1 or a third party owns and operates the Gift Certificate Order Server (B). In the case of a newly purchased gift certificate, the system generates a gift certificate with a Unique ID, new Authentication Code and new value. The new gift certificate is recorded in Database (E) using the Unique Gift Certificate ID as the primary key. A new digital or physical gift certificate is issued to Recipient (C). In the case of an existing gift certificate is being reissued, the system updates the gift certificate record corresponding to the gift certificate's Unique ID (primary key) in Database (E) with the new Authentication Code and new Value equal to the remaining balance of the gift certificate. It then issues an updated digital or physical gift certificate with a new Authentication Code and new Value to Recipient (C). The gift certificate is read by the gift certificate processing device (F) at the merchant.

The Gift Certificates with Unique ID and Authentication Code depicted in FIG. 2 may be fulfilled electronically (e.g. via e-mail) or printed as a physical certificate. The system and associated methods described herein apply equally to scenarios where the gift certificates are electronic or physical certificates.

The system and associated methods described herein apply equally regardless of whether the system requires the gift certificate to be validated by the Gift Recipient (C) prior to use or the gift certificate is immediately valid for purchase when issued or reissued.

The system and associated methods described herein apply equally to purchases at merchants with physical store locations and to merchants with “on-line” Internet-based stores.

The system and associated methods described herein apply equally whether the gift certificate Authentication Code appears on the gift certificate (is printed on the gift certificate along with the Unique ID) or the Authentication Code does not appear on the gift certificate and must be presented by the gift certificate owner to the merchant when the gift certificate is redeemed.

The system and associated methods described herein apply equally whether the value of the gift certificate appears on the gift certificate or the gift certificate value is known only when the merchant attempts to validate the gift certificate.

Since the system and methods described herein protect the unused balance of the gift certificate, the system and methods described herein can be easily extended to enable reissuing of lost certificates upon customer request—simply by triggering the gift certificate reissue mechanism that normally occurs when a gift certificate is partially used and has a remaining balance.

In an embodiment, the gift certificate's Unique ID is generated by the system in a predictable manner (e.g. sequential numbers) for easy gift certificate tracking and managing. Since the Unique ID is static and different from all other gift certificates in the system, it serves as the primary key of the gift certificate record in the database. The gift certificate can always be selected and updated using this Unique ID/primary key, regardless of how other attributes of the gift certificate may change.

In an embodiment, the gift certificate's Authentication Code is generated in a truly random fashion to thwart brute force or arbitrary guessing techniques that might be employed by would-be forgers who want to commit gift certificate fraud. Not only does this random Authentication Code protect the unused balance of the gift certificate for the gift recipient, but it protects the owner/operator of the gift certificate program from counterfeit gift certificates (since the counterfeiter would need to guess both the gift certificate ID and the associated random Authentication Code). The Authentication Code is generated in such a way as to preclude repeated, duplicate Authentication Codes for the same gift certificate, ensuring that old Authentication Codes for the gift certificate can never become valid again. The owner/operator of the gift certificate program that employs the system and associated methods described herein can increase the complexity of the Authentication Code (and thus decrease the likelihood of successful counterfeiters) by increasing the number of characters in the Authentication Code and by increasing the number of valid symbols in the Authentication Code (e.g. making Authentication Codes that consist of both numbers and letters instead of only numbers).

Since the Unique ID and separate Authentication Code are used to protect the unused balance of the gift certificate, they can also be used to invalidate the gift certificate for reissue in the case of a lost gift certificate without losing the static identity/primary key (Unique ID) of the gift certificate which is important for tracking and managing gift certificates. The lost gift certificate can be easily invalidated by changing its Authentication Code and then reissued to either the original purchaser of the gift certificate (gift giver) or to the gift recipient.

Since federal and state laws may require lengthy gift certificate funds availability durations that exceed the desired gift certificate expiration (e.g. the owner/operator of the gift certificate program may wish for 1-year gift certificate expiration dates in order to allow updates to gift certificate formats without requiring the system to support old formats, while state and federal laws may require 5-year availability of gift certificate funds), the owner/operator of the gift certificate program can employ the system and associated methods described here-in to enforce a 1-year expiration of the gift certificate (or any desired expiration duration) at which time the gift recipient requests a reissued gift certificate that has a value equal to the available funds for the gift certificate. The reissued gift certificate retains its original Unique ID and has a new random Authentication Code. Since the gift certificate retains its Unique ID, the gift certificate can expire multiple times within the funds availability period and the history of the gift certificate can be easily tracked for the recorded life of the gift certificate, simply by selecting the Unique ID (primary key) of the gift certificate record.

Since the Order Server (B) changes the gift certificate's Authentication Code immediately when the gift certificate is partially redeemed, the system and associated methods described herein prevent accidental duplicate redemption of a gift certificate. An accidental subsequent attempt by the merchant to redeem the gift certificate will result in an “Invalid” response from the Order Server (B).

Since the Order Server (B) changes the gift certificate's Authentication Code immediately when the gift certificate is partially redeemed, the system and associated methods described herein prevent fraudulent attempts to simultaneously redeem the gift certificate at multiple disparate merchants. The Order Server (B) changes the gift certificate's Authentication Code after the first successful partial redemption of the gift certificate, causing all subsequent attempts to partially or fully redeem the gift certificate with the “old” Authentication Code to fail with an “Invalid” error code.

Since the gift certificate can be uniquely and reliably identified by its Unique ID without specifying the private Authentication Code, the system and associated methods described herein can openly report the status of a gift certificate (remaining balance, expiration date, etc.) without compromising the security of the gift certificate's unused remaining balance. For example, the system and associated methods described herein support the following scenario: if a gift recipient would like to submit a query for the status of all of their gift certificates, the gift recipient could submit a query that specifies the e-mail address associated with their gift certificates. The system could respond with a report that lists all selected gift certificates (listing the Unique ID only, not the Authentication Code) and the associated gift certificate status (remaining balance, expiration date, etc.) without compromising the security of the remaining balance(s), because the Authentication Code remains private and is not part of the report.

Further protection of the unused gift certificate balance may be provided by implementing a method that prevents counterfeiting of a scannable gift certificate code. As used herein, a “scannable” code is any code that is capable of being scanned or otherwise read, including bar codes, QR codes, RFID tags, or any other machine-readable code. In an embodiment, to expedite the processing of gift certificates by the merchant(s) who accept them, a gift certificate has a standards-based code that can be scanned (e.g. bar code or QR code). Since the code is standards-based, the information contained in the scannable code is public and can be easily viewed with many commonly available scanning applications and devices. Also, because the methods used to produce the scannable codes are standard and well-known, the scannable codes are very easy to produce with commonly available applications. The method described herein prevents the production of counterfeit gift certificates that contain counterfeit scannable codes, because even when all of the gift certificate attributes are known by the would-be counterfeiter, a valid, scannable code cannot be produced by the would-be counterfeiter.

The basis for this method is a hash value that is included as additional information in the gift certificate's scannable code without necessitating the creation, storage and management of additional gift certificate attributes. This hash value can be produced via commonly-accepted, secure hashing algorithms like the Secure Hash Algorithm (SHA). The hash value is not itself a stored attribute of the gift certificate (as would be a security code added to the gift certificate in addition to the gift certificate's ID), but rather is produced by hashing one or more of the existing gift certificate attributes in a way that is known only by the system that produces, issues, validates and processes the gift certificates. Even though the hash, as an additional piece of information in the scannable code, is completely public and visible, without the complete hashing algorithm, a would-be counterfeiter who knows all of the gift certificate attributes would not know how to produce a valid hash and thus would have no way to produce a valid, scannable gift certificate.

The counterfeit-prevention method described herein applies equally well to gift certificates that are printed (e.g. paper) or digital (e.g. an image on a smartphone) and can be applied to all gift certificates that have a scannable code like a QR code or bar code.

The counterfeit-prevention method described herein applies equally well to gift certificates with any scannable code and is not limited to gift certificates with bar codes and QR codes.

The method described herein has the added benefit of being changeable without adding any new stored gift certificate attributes. The design of the gift certificate database can thus remain unchanged, while the attributes and hashing algorithm used to create the hash can be changed to provide an added degree of counterfeit prevention that adapts to changing security needs over time.

### EXAMPLE 1

The simplest case is when the gift certificate has a single alphanumeric ID with other attributes, where the other attributes include the gift certificate amount, color, personalized message, etc. Without this counterfeit-prevention method, the gift certificate's scannable code would contain only the alphanumeric ID as depicted in FIG. 6a. When the gift certificate ID is scanned, the alphanumeric ID is easily read and displayed. To produce a counterfeit gift certificate, a counterfeiter would need only an existing gift certificate (to copy the format and appearance of the gift certificate) and a code generator (as depicted in FIG. 6b) to create scannable codes that codify the would-be counterfeiter's educated guesses of valid gift certificate IDs. Without the counterfeit prevention method described herein, a counterfeiter could easily produce multiple gift certificates that visually appear to be authentic with codes that are scannable and then disseminate the counterfeit gift certificates to initiate a “brute force attack,” whereby through one or more lucky guesses of gift certificate ID(s), one or more of the gift certificates produced are valid with real virtual currency value. The counterfeit gift certificates would not be discovered until after they had already been exchanged for merchant services and/or merchandise.

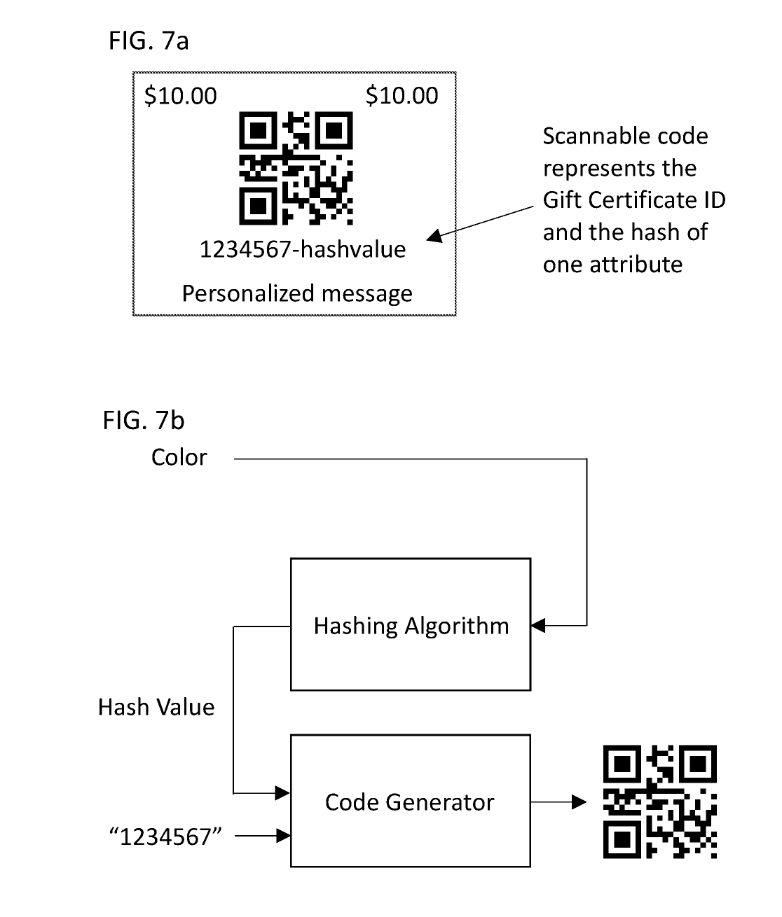

Now apply the counterfeit prevention method described herein to this simplest case, where the gift certificate has a single ID. A hashed value could be added to the gift certificate ID as shown in FIG. 7a, where the hashed value is derived from the gift certificate color—a stored and publicly visible gift certificate attribute as depicted in FIG. 7b. For a blue gift certificate with an ID of “1234567,” the system that produces the gift certificate would generate a scannable code that represents the gift certificate ID and the hash of “blue” (the gift certificate color). When scanned, the scanner would reveal the gift certificate ID and the hashed value of the color, both of which would be submitted to the gift certificate processing system for validation. Short of copying the original gift certificate, a would-be counterfeiter would not be able to produce a valid gift certificate even if the would-be counterfeiter knows that the gift certificate with ID “1234567” is blue, because the would-be counterfeiter does not know the hashing algorithm or the attribute that is hashed. The gift certificate processing system would reject the counterfeit gift certificate, because of the incorrect hash.

### EXAMPLE 2

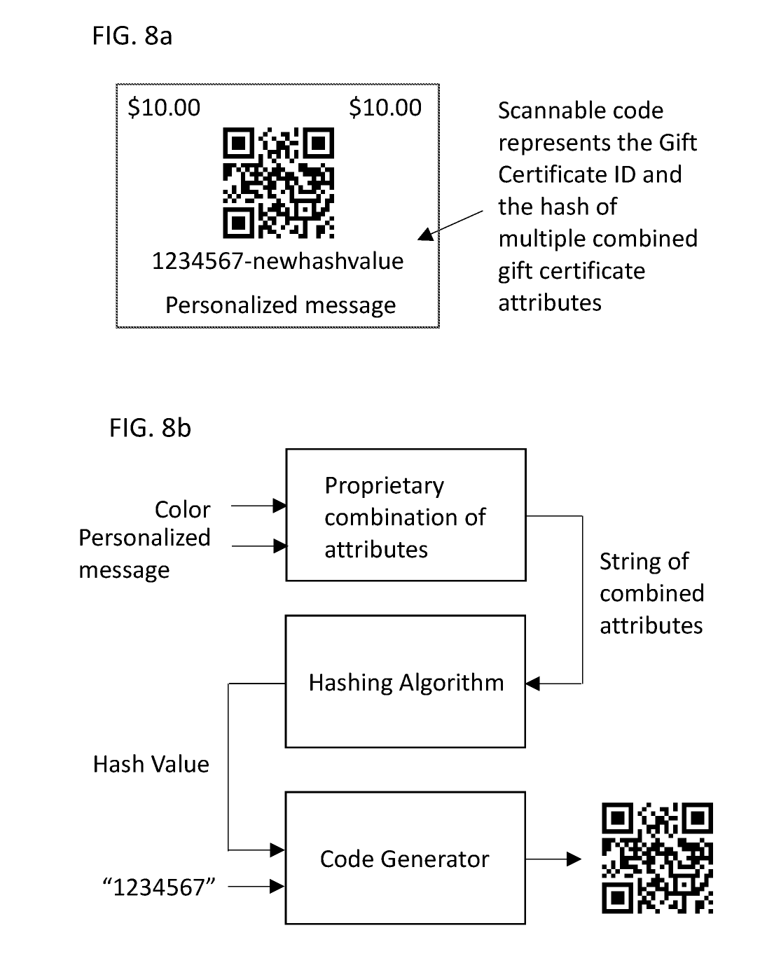

The counterfeit prevention method is easily extended to augment gift certificate security without adding any new stored attributes (e.g. security codes) to the gift certificate. Assume that the same gift certificate described in Example 1 (with ID “1234567”) has a personalized message (a message to the gift recipient from the gift sender). The system that produces the gift certificates could create a hash value derived from the color (“blue”) and the personalized message as shown in FIG. 8b to produce the gift certificate shown in FIG. 8a. A scanner would reveal that the gift certificate has an ID of “1234567” and a hash value. In order to produce a valid gift certificate, a would-be counterfeiter who knows the gift certificate ID, color and personal message would still need to know the hashing algorithm and the manner in which the color and personal message are combined before hashing.

### EXAMPLE 3

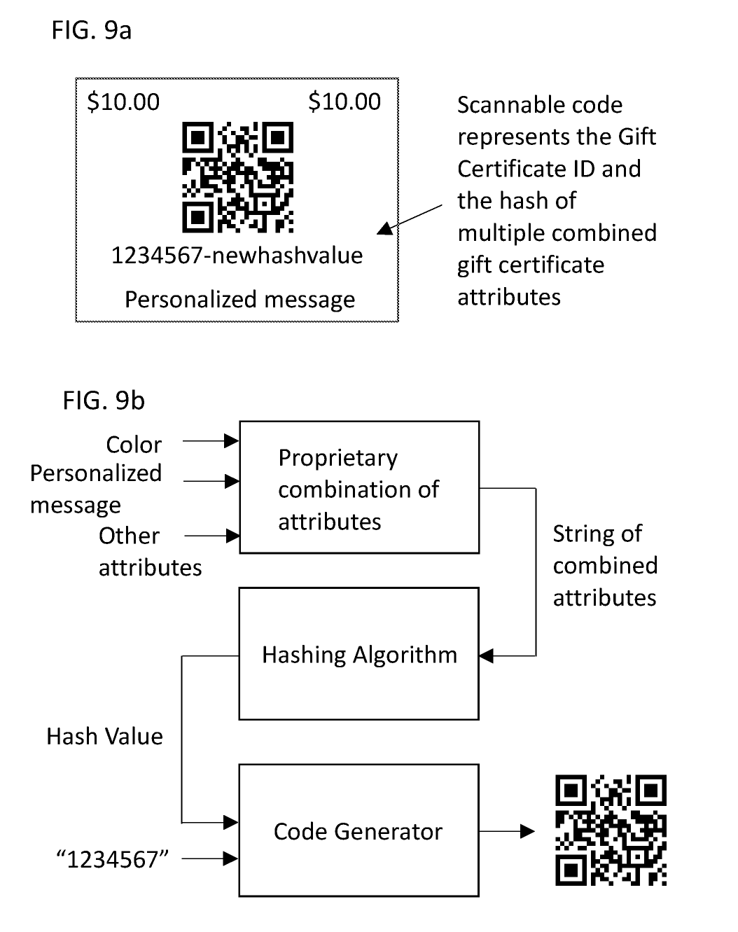

Extend Example 2 by combining and hashing a combination of multiple gift certificate attributes (beyond the color and personalized message) as shown in FIG. 9b. Each additional attribute that is included in the hash results in increased complexity that increases the counterfeit-prevention efficacy of the method described herein without adding any new stored attributes to the gift certificate (and thus without requiring any database changes).

Thus, there has been disclosed above a system and method for generating, recording, managing and redeeming gift certificates that achieves substantial benefits over conventional systems, such as increased security (including increased protection of the unused balance and anti-counterfeit measures), faster redemption times, and fewer erroneous redemption transactions.

At least some aspects disclosed can be embodied, at least in part, in software. That is, the techniques may be carried out in a special purpose or general purpose computer system or other data processing system in response to its processor, such as a microprocessor, executing sequences of instructions contained in a memory, such as ROM, volatile RAM, non-volatile memory, cache or a remote storage device. Functions expressed in the claims may be performed by a processor in combination with memory storing code and should not be interpreted as means-plus-function limitations.

Routines executed to implement the embodiments may be implemented as part of an operating system, firmware, ROM, middleware, service delivery platform, SDK (Software Development Kit) component, web services, or other specific application, component, program, object, module or sequence of instructions referred to as “computer programs.” Invocation interfaces to these routines can be exposed to a software development community as an API (Application Programming Interface). The computer programs typically comprise one or more instructions set at various times in various memory and storage devices in a computer, and that, when read and executed by one or more processors in a computer, cause the computer to perform operations necessary to execute elements involving the various aspects.

A machine-readable medium can be used to store software and data which when executed by a data processing system causes the system to perform various methods. The executable software and data may be stored in various places including for example ROM, volatile RAM, non-volatile memory and/or cache. Portions of this software and/or data may be stored in any one of these storage devices. Further, the data and instructions can be obtained from centralized servers or peer-to-peer networks. Different portions of the data and instructions can be obtained from different centralized servers and/or peer-to-peer networks at different times and in different communication sessions or in a same communication session. The data and instructions can be obtained in entirety prior to the execution of the applications. Alternatively, portions of the data and instructions can be obtained dynamically, just in time, when needed for execution. Thus, it is not required that the data and instructions be on a machine-readable medium in entirety at a particular instance of time.

Examples of computer-readable media include but are not limited to recordable and non-recordable type media such as volatile and non-volatile memory devices, read only memory (ROM), random access memory (RAM), flash memory devices, floppy and other removable disks, magnetic disk storage media, optical storage media (e.g., Compact Disk Read-Only Memory (CD ROMS), Digital Versatile Disks (DVDs), etc.), among others.

In general, a machine readable medium includes any mechanism that provides (e.g., stores) information in a form accessible by a machine (e.g., a computer, network device, personal digital assistant, manufacturing tool, any device with a set of one or more processors, etc.).

In various embodiments, hardwired circuitry may be used in combination with software instructions to implement the techniques. Thus, the techniques are neither limited to any specific combination of hardware circuitry and software nor to any particular source for the instructions executed by the data processing system.

As used herein, and especially within the claims, ordinal terms such as first and second are not intended, in and of themselves, to imply sequence, time or uniqueness, but rather are used to distinguish one claimed construct from another. In some uses where the context dictates, these terms may imply that the first and second are unique. For example, where an event occurs at a first time, and another event occurs at a second time, there is no intended implication that the first time occurs before the second time. However, where the further limitation that the second time is after the first time is presented in the claim, the context would require reading the first time and the second time to be unique times. Similarly, where the context so dictates or permits, ordinal terms are intended to be broadly construed so that the two identified claim constructs can be of the same characteristic or of different characteristic.

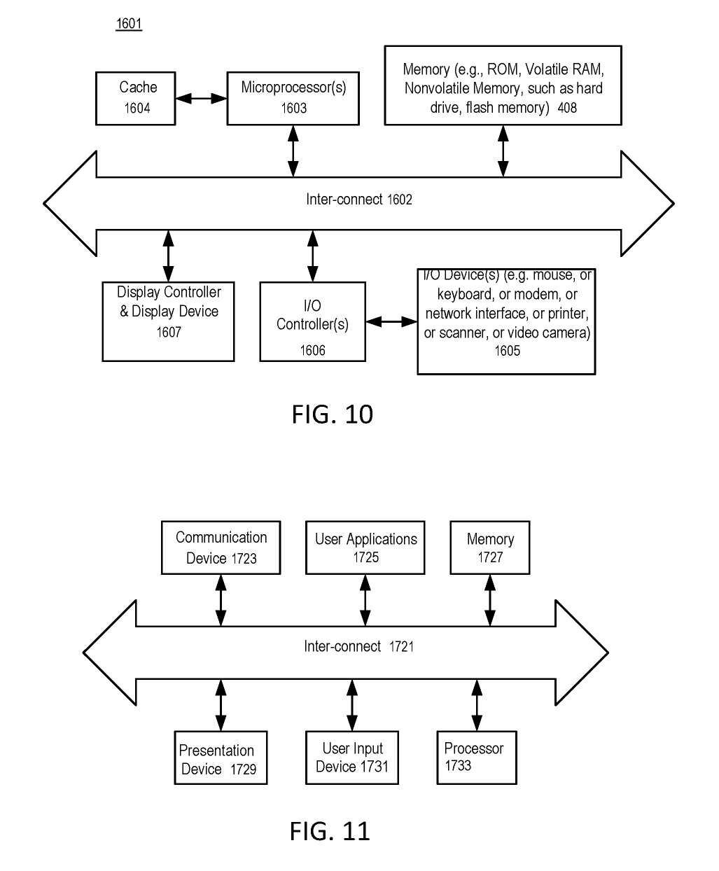

FIG. 10 shows a block diagram of a data processing system that can be used in various embodiments of the disclosed systems and methods. While FIG. 10 illustrates various components of a computer system, it is not intended to represent any particular architecture or manner of interconnecting the components. Other systems that have fewer or more components may also be used.

In FIG. 10, the system 1601 includes an inter-connect 1602 (e.g., bus and system core logic), which interconnects a microprocessor(s) 1603 and memory 1608. The microprocessor 1603 is coupled to cache memory 1604 in the example of FIG. 6.

The inter-connect 1602 interconnects the microprocessor(s) 1603 and the memory 1608 together and also interconnects them to a display controller and display device 1607 and to peripheral devices such as input/output (I/O) devices 1605 through an input/output controller(s) 1606. Typical I/O devices include mice, keyboards, modems, network interfaces, printers, scanners, video cameras and other devices that are well known in the art.

The inter-connect 1602 may include one or more buses connected to one another through various bridges, controllers and/or adapters. In one embodiment the I/O controller 1606 includes a USB (Universal Serial Bus) adapter for controlling USB peripherals, and/or an IEEE-1394 bus adapter for controlling IEEE-1394 peripherals.

The memory 1608 may include ROM (Read-Only Memory), and volatile RAM (Random Access Memory) and non-volatile memory, such as hard drive, flash memory, etc.

Volatile RAM is typically implemented as dynamic RAM (DRAM) that requires power continually in order to refresh or maintain the data in the memory. Non-volatile memory is typically a magnetic hard drive, a magnetic optical drive, or an optical drive (e.g., a DVD RAM), or other type of memory system which maintains data even after power is removed from the system. The non-volatile memory may also be a random access memory.

The non-volatile memory can be a local device coupled directly to the rest of the components in the data processing system. A non-volatile memory that is remote from the system, such as a network storage device coupled to the data processing system through a network interface such as a modem or Ethernet interface, can also be used.

In an embodiment, the various servers supporting the platform are implemented using one or more data processing systems as illustrated in FIG. 10. In an embodiment, user devices such as those used to utilize the system shown in FIGS. 1-9 are implemented using one or more data processing system as illustrated in FIG. 10.

In some embodiments, one or more servers of the system illustrated in FIG. 10 are replaced with the service of a peer-to-peer network or a cloud configuration of a plurality of data processing systems, or a network of distributed computing systems. The peer-to-peer network, or cloud based server system, can be collectively viewed as a server data processing system.

Embodiments of the disclosure can be implemented via the microprocessor(s) 1603 and/or the memory 1608. For example, the functionalities described above can be partially implemented via hardware logic in the microprocessor(s) 1603 and partially using the instructions stored in the memory 1608. Some embodiments are implemented using the microprocessor(s) 1603 without additional instructions stored in the memory 1608. Some embodiments are implemented using the instructions stored in the memory 1608 for execution by one or more general-purpose microprocessor(s) 1603. Thus, the disclosure is not limited to a specific configuration of hardware and/or software.

FIG. 11 shows a block diagram of a user device. In FIG. 11, the user device includes an inter-connect 1721 connecting a communication device 1723, such as a network interface device, a presentation device 1729, such as a display screen, a user input device 1731, such as a keyboard or touch screen, user applications 1725 implemented as hardware, software, firmware or a combination of any of such media, such various user applications (e.g. apps), a memory 1727, such as RAM or magnetic storage, and a processor 1733 that, inter alia, executes the user applications 1725.

In one embodiment, the user applications implement one or more user interfaces displayed on the presentation device 1729 that provides users the capabilities to, for example, access the Internet, and display and interact with user interfaces provided by the platform.

In one embodiment, users use the user input device 1731 to interact with the device via the user applications 1725 supported by the device. The user input device 1731 may include a text input device, a still image camera, a video camera, and/or a microphone.

While some embodiments can be implemented in fully functioning computers and computer systems, various embodiments are capable of being distributed as a computing product in a variety of forms and are capable of being applied regardless of the particular type of machine or computer-readable media used to actually effect the distribution.

The above embodiments and preferences are illustrative of the present invention. It is neither necessary, nor intended for this patent to outline or define every possible combination or embodiment. The inventor has disclosed sufficient information to permit one skilled in the art to practice at least one embodiment of the invention. The above description and drawings are merely illustrative of the present invention and that changes in components, structure and procedure are possible without departing from the scope of the present invention as defined in the following claims. For example, elements and/or steps described above and/or in the following claims in a particular order may be practiced in a different order without departing from the invention. Thus, while the invention has been particularly shown and described with reference to embodiments thereof, it will be understood by those skilled in the art that various changes in form and details may be made therein without departing from the spirit and scope of the invention.

What is claimed is:

1. A system for generating, recording, managing and redeeming gift certificates that securely retain their unused balance that facilitates multiple partial uses of the same gift certificate while thwarting theft of the unused balance, comprising:
a data store including a plurality of records each corresponding to a different one of a plurality gift certificates;
a merchant gift certificate processing device;
a computer processor coupled to the data store and in communication with the merchant gift certificate processing device through a network, the computer processor being programmed to:
i) associate a static unique identifier with a first gift certificate among the plurality of gift certificates, the static unique identifier being unique with respect to other ones of the plurality of gift certificates, the static unique identifier remaining constant for the recorded life of the first gift certificate;
ii) associate a first balance and a first random authentication code with the first gift certificate, the random authentication code being usable to authenticate the first gift certificate;
iii) upon receiving an indication from the merchant gift certificate processing device that the first gift certificate is to be used in an amount less than the first balance, associating a second balance and a second random authentication code with the first gift certificate's static unique identifier, the second random authentication code being different from any authentication code previously assigned to the first gift certificate's static unique identifier;
wherein the computer processor protects unused balances of partially redeemed gift certificates from unauthorized/fraudulent use by persons other than authorized gift recipients and prevents accidental duplicate partial redemptions of gift certificates that would otherwise result from accidental subsequent attempts to redeem the gift certificate after an intended partial redemption is processed.

2. The system for generating, recording, managing and redeeming gift certificates according to claim 1, wherein the computer processor is programmed to receive the indications from a single merchant.

3. The system for generating, recording, managing and redeeming gift certificates according to claim 1, wherein the computer processor is programmed to receive the indications from multiple unaffiliated merchants.

4. The system for generating, recording, managing and redeeming gift certificates according to claim 3, wherein the computer processor is programmed to prevent fraudulent attempts to simultaneously redeem the first gift certificate at multiple unaffiliated merchants.

5. The system for generating, recording, managing and redeeming gift certificates according to claim 3, wherein the computer processor is programmed to allow gift certificate program operators to require gift recipient renewal of gift certificates that expire in periods shorter than funds availability durations required by state or federal gift certificate laws.

6. The system for generating, recording, managing and redeeming gift certificates according to claim 1, wherein the static unique identifier comprises a multi-symbol identifier.

7. The system for generating, recording, managing and redeeming gift certificates according to claim 1, wherein the first and second random authentication codes each comprise a different multi-symbol identifier.

8. The system for generating, recording, managing and redeeming gift certificates according to claim 1, wherein the computer processor is further programmed to store in the data store design attributes associated with the first gift certificate.

9. The system for generating, recording, managing and redeeming gift certificates according to claim 8, wherein the design attributes comprise color, style, message, gift giver name, and gift recipient name.

10. The system for generating, recording, managing and redeeming gift certificates according to claim 1, wherein the first authentication code comprises an authentication code with at least one randomly generated symbol.

11. The system for generating, recording, managing and redeeming gift certificates according to claim 10, wherein the first authentication code comprises a code known only by the gift recipient and the computer processor.

12. The system for generating, recording, managing and redeeming gift certificates according to claim 1, wherein the first gift certificate has a scannable code.

13. The system for generating, recording, managing and redeeming gift certificates according to claim 12, wherein the scannable code includes a hash value and the computer processor is programmed to use a secure hashing algorithm to generate the hash value to produce the first gift certificate, such that a would-be counterfeiter who knows all gift certificate attributes would not know how to produce a valid hash.

14. The system for generating, recording, managing and redeeming gift certificates according to claim 13, wherein the hash value comprises a combination of gift certificate attributes.

15. The system for generating, recording, managing and redeeming gift certificates according to claim 13, wherein the hashing algorithm, attributes, and how the attributes are combined in the hash are known only to the computer processor.
